(19) United States
(12) Patent Application Publication
(10) Pub. No.: US 2005/0235139 A1
(43) Pub. Date: Oct. 20, 2005

(54) Multiple user desktop system

(76) Inventors: Robert John Hoghaug, Prior Lake, MN (US); Thomas Andrew Hoghaug, Chanhassen, MN (US)

Correspondence Address: HUGH D JAEGER, 1000 SUPERIOR BLVD, SUITE 302, WAYZATA, MN, 553911873, US

(21) Appl. No.: 10/888,039

(22) Filed: Jul. 9, 2004

Related U.S. Application Data
(60) Provisional application No. 60/486,147, filed on Jul. 10, 2003.

(51) Int. Cl. G06F 15/177

(52) U.S. Cl. 713/2

(57) ABSTRACT

The multiple user desktop (MUD) GINA is a loadable dynamic link library (DLL) intended to replace the default Microsoft GINA. It has the ability to create secure, private logon sessions for each user that logs on to the system. There can be up to fourteen (14) users logged in at the same time and each user will have their own desktop environment. Auto log off functions may be set based on time of inactivity and/or number of individual users. The MUD Gina functions in a domain and non-networked environments and needs no added hardware.

### CROSS REFERENCES TO RELATED APPLICATIONS

This application claims priority from the earlier filed U.S. Provisional Application No. 60/486,147 filed Jul. 10, 2003, entitled “Multiple Private Desktop System.” The prior application is hereby incorporated into this application by reference as if fully set forth herein.

### BACKGROUND OF THE INVENTION

1. Field of the Invention

The MUD Gina is intended for shared computers used in Kiosks, Homes, Nursing Stations and anywhere more than one User must utilize the same computer. Along with shared computers the MUD GINA can also be used by a single user who needs to logon to their computer using more than one logon account. This is useful for things like multiple email accounts or for launching specific applications needing special credentials. The MUD GINA is also intended for use by individuals and businesses that need to limit access to secured resources because of Corporate or Government regulations (i.e., HIPPA).

2. Description of the Prior Art

Currently, it is possible for multiple users to logon to the same system simultaneously, but this is limited to the most recent version of the Microsoft Windows Desktop Operating System (Windows XP), and it is disabled if the system is joined to a network domain. Since most businesses utilize their computers as part of a network domain and/or are not running the latest version of Microsoft Windows, there is only way to address the problem of maintaining secure, audited secure resource access on a shared workstation; that is to make each user perform a logon to the system, access the secure resources and then logoff. This process can be cumbersome and time consuming as it requires a user to always remember to close out their applications and logoff when they are finished with the system. A worse scenario may be created if a user forgets to logoff thus leaving the system in a state where the secure resources can be compromised by anyone who may have access to the terminal or system. Even if proper security is put in place, such as a short timeout before a screen lock, problems may still occur. For instance, if the system goes into the locked state either by user intervention or by inactivity and another User with insufficient privilege to unlock the system needs access, there is no way it can be unlocked. Another significant issue is the time it takes to logon to system and then logon to the applications required to access the secure resources. Since a user must logoff the system whenever they are finished using it, they must also go through the Logon process each time the want to access it resulting in severely diminished productivity of the shared resources. This is problematical and inefficient for the user, system, network and the application servers.

The MUD GINA is capable of creating individual multiple private desktops. Many of the current competitors to this product use a method called “window hiding.” They simply log in a “Generic User” and when a person needs access to the system a “pseudo login” is performed which merely sets up the desktop for the user who has just authenticate and “hides” the windows of the last user. The problem with this type of method is that all the hidden applications that are running can be accessed very easily though certain task managing applications; i.e., one user can access another user's programs by selecting and opening it in the task manager application. The end result is a veil of security which does not protect secure resources from knowledgeable individuals. The MUD GINA actually creates a desktop for each of the users within the operating system and these desktop are created in protected memory that keeps other users form accessing the applications. Even a knowledgeable person cannot access another user's processes (applications and data).

The MUD GINA is a full replacement GINA, meaning that it does not use any abilities of the existing Microsoft GINA. Many replacement GINAs are actually “pass-through” GINAs which means that they call on the Microsoft GINA to do all the work and they simply put up custom screens or collect authentication data for passing to the Microsoft GINA. It is not possible for these GINAs to run without the Microsoft GINA present on the system. In contrast, the MUD GINA does not call on any functions or require any contact with the Microsoft GINA. The result is increased security by having it not rely on another entity to do the authentication and increases what type of authentication can be performed within the system. With a pass-through GINA all authentication mechanisms must reduce the authentication to one of two types; a user name and password or a certificate. This means that if an unscrupulous person knows either the username or password, or has access to the certificate then they can bypass the multiple authentication levels and gain system access. The MUD GINA performs its own entire authentication of credentials, which means it does not “boil” anything down to a few simple credentials. If a user is required to perform a smart card login with a SecurID token then this is the only way the user will be able to logon.

The “Achilles heal” of any pass-through GINA or one that cannot run without the Microsoft GINA present is the safe mode access problem. If a user reboots a system and enters “safe mode” then the Microsoft operating system will not load third part GINAs and will instead load the default Microsoft GINA. At this point a user is presented with a user name and password logon. The username and password logon is much easier to crack than a multi-factor login method. Once access is obtained the third part GINA can be removed from the system allowing access to it in “normal mode” via the standard Microsoft GINA. The MUD GINA addresses this by not requiring the Microsoft GINA to be present on the system. With the proper tools and installation, the MUD GINA can even be constructed to look and function like the Microsoft GINA which in turn can prevent a user from obtaining access to the system through the username and password hack.

### SUMMARY OF THE INVENTION

The multiple user desktop (MUD) graphical identification and authentication (GINA) dynamic link library (DLL) is designed to run on Microsoft Windows Operating Systems that are based on, or derived from, Windows 32 bit NT. A DLL is a module that can be loaded by other modules (applications) to add functionality or perform a service. The MUD GINA is intended to be loaded by the Microsoft Winlogon.exe application which is responsible for the creation of desktops, loading users' profiles, running policies and starting the user's shell. A GINA is responsible for authenticating the User who is attempting to logon to the Windows NT based system. If the user authenticates successfully then the GINA informs Winlogon that the user is valid and to start the process of creating an interactive desktop. If the user is not valid the GINA returns a failure to Winlogon so it may display the locked or logged out screen. Winlogon is specifically designed to allow only a single user to logon to a system at any time. Winlogon is not designed to handle more than one interactive logon session. Because of Winlogon's inability to deal with more than one interactive logon session the MUD GINA was created to more closely resemble Winlogon than a standard GINA. The MUD GINA is designed to take on almost all of the abilities of Winlogon so that it can create more than one interactive desktop at a time. The limitation on interactive desktops is a Winlogon limitation and not the operating systems. Since Winlogon can only deal with what amounts to a single logged on user at a time, the MUD GINA has to fool Winlogon into thinking that a “dummy” user is always logged into the system and this is done when the first user performs a logon. The MUD does all the work of creating the interactive logon session and the desktop. It also executes the profiles, runs the policies and starts the user's shell. Since Winlogon is expecting to do this, the MUD sends back a “dummy” user which in this case is the “system” user (a user known to always be present on every system). This has to be done because if the MUD sent back the first user to Winlogon and then later logged him off it would create inconsistencies in Winlogon and cause it to stop functioning. The whole interface and interaction is designed so that the user never sees anything different and logons look the same as if there were be done by Winlogon itself. Everything else functions the same with the exception of the unlocked screen. After a user “locks the screen” by executing a SAS event (e.g., hitting Ctrl-Alt-Del) or it is locked because of inactivity, the user must unlock the system to continue to use it. This is where the MUD GINA functionality changes significantly. The Microsoft GINA is design to only allow the user who locked the screen to unlock it; however, it also allows an administrator to log the user off which can be dangerous or disruptive.

After a SAS event is received the MUD GINA allows the same User to unlock the screen just like the Microsoft GINA. But what is really significant and different is that the MUD GINA allows a new user to logon to the system at the locked screen. If a new username is entered or a new smart card or token is placed in a reader on the system then the MUD GINA will allow this new user to logon to the system. This is accomplished by simply validating the credentials supplied by the user and then checking them against the currently logged on users to see if there is a match. If there is a match then the appropriate desktop is set in Winlogon and a screen unlock message is returned to Winlogon. But if the user is not found then the MUD GINA assumes it is a new user and goes about the process of creating the interactive session and desktop, executing the profile, running the policies, and starting the shell.

At this point, the new desktop is set in Winlogon by a call to WlxSetUserDesktop and a value WLX_SAS_ACTION_WKSTA_UNLOCK is returned. Winlogon will unlock the workstation setting the desktop to the new user's desktop. When a user wishes to logoff the system it works basically the same but in reverse. When the user selects logoff, after a SAS event or from the start menu, MUD GINA is called to assist in the Logoff and clean up after the user. If this is not the last user then MUD GINA closes the desktop and performs a logoff of the user and a cleanup of the user account data; a value of WLX_SAS_ACTION_WKSTA_LOCK is then returned to Winlogon as there is not a valid user desktop to display and the machine is left in a locked state.

In the event the User who wishes to logoff is the last user or the user has the privilege (is an admin) to perform a logoff of all the user things happen differently. Either the user's desktop is closed and the user is logged off or, if it is a logoff all users then all users are logged off one by one with each desktop being closed and the user is logged off and cleaned up. Once completed, there are no users logged on so the “dummy” user can be freed up and sent back to Winlogon allowing it to perform its cleanup and logoff the system user. At this point, Winlogon sets its internal state to “logged out SAS” and displays the original splash screen. A shutdown or reboot will also force the logoff and closing of all desktops.

During this entire process there is a loosely coupled logging service (an application that runs on the system all the time from startup to shutdown) which is used for auditing purposes. It is an application that has an engine designed to process messages. The log messages come into a queue from the MUD GINA and are then passed to a process thread where they are “cracked” and the appropriate operations are performed on them. All log messages are sent to this logger to be outputted to a file or through a database layer to a specified database for viewing and auditing. This system is secure and provides for a detailed trail of all activities performed by individual users.

According to one embodiment of the present invention, there is provided a multiple user desktop (MUD) graphical identification and authentication (GINA) dynamic link library (DLL) is designed to run on Microsoft Windows Operating Systems that are based on, or derived from, Windows 32 bit NT. A DLL is a module that can be loaded by other modules (applications) to add functionality or perform a service. The MUD GINA is intended to be loaded by the Microsoft Winlogon.exe application which is responsible for the creation of desktops, loading users' profiles, running policies and starting the user's shell. A GINA is responsible for authenticating the User who is attempting to logon to the Windows NT based system. If the user authenticates successfully then the GINA informs Winlogon that the user is valid and to start the process of creating an interactive desktop. If the user is not valid the GINA returns a failure to Winlogon so it may display the locked or logged out screen. Winlogon is specifically designed to allow only a single user to logon to a system at any time. Winlogon is not designed to handle more than one interactive logon session. Because of Winlogon's inability to deal with more than one interactive logon session the MUD GINA was created to more closely resemble Winlogon than a standard GINA. The MUD GINA is designed to take on almost all of the abilities of Winlogon so that it can create more than one interactive desktop at a time. The limitation on interactive desktops is a Winlogon limitation and not the operating systems. Since Winlogon can only deal with what amounts to a single logged on user at a time, the MUD GINA has to fool Winlogon into thinking that a “dummy” user is always logged into the system and this is done when the first user performs a logon. The MUD does all the work of creating the interactive logon session and the desktop. It also executes the profiles, runs the policies and starts the user's shell. Since Winlogon is expecting to do this, the MUD sends back a “dummy” user which in this case is the “system” user (a user known to always be present on every system). This has to be done because if the MUD sent back the first user to Winlogon and then later logged him off it would create inconstancies in Winlogon and cause it to stop functioning. The whole interface and interaction is designed so that the user never sees anything different and logons look the same as if there were be done by Winlogon itself. Everything else functions the same with the exception of the unlocked screen. After a user “locks the screen” by executing a SAS event (e.g., hitting Ctrl-Alt-Del) or it is locked because of inactivity, the user must unlock the system to continue to use it. This is where the MUD GINA functionality changes significantly. The Microsoft GINA is design to only allow the user who locked the screen to unlock it; however, it also allows an administrator to log the user off which can be dangerous or disruptive.

After a SAS event is received the MUD GINA allows the same User to unlock the screen just like the Microsoft GINA. But what is really significant and different is that the MUD GINA allows a new user to logon to the system at the locked screen. If a new username is entered or a new smart card or token is placed in a reader on the system then the MUD GINA will allow this new user to logon to the system. This is accomplished by simply validating the credentials supplied by the user and then checking them against the currently logged on users to see if there is a match. If there is a match then the appropriate desktop is set in Winlogon and a screen unlock message is returned to Winlogon. But if the user is not found then the MUD GINA assumes it is a new user and goes about the process of creating the interactive session and desktop, executing the profile, running the policies, and starting the shell.

At this point, the new desktop is set in Winlogon by a call to WlxSetUserDesktop and a value WLX_SAS_ACTION_WKSTA_UNLOCK is returned. Winlogon will unlock the workstation setting the desktop to the new user's desktop. When a user wishes to logoff the system it works basically the same but in reverse. When the user selects logoff, after a SAS event or from the start menu, MUD GINA is called to assist in the Logoff and clean up after the user. If this is not the last user then MUD GINA closes the desktop and performs a logoff of the user and a cleanup of the user account data; a value of WLX_SAS_ACTION_WKSTA_LOCK is then returned to Winlogon as there is not a valid user desktop to display and the machine is left in a locked state.

In the event the User who wishes to logoff is the last user or the user has the privilege (is an admin) to perform a logoff of all the user things happen differently. Either the user's desktop is closed and the user is logged off or, if it is a logoff all users then all users are logged off one by one with each desktop being closed and the user is logged off and cleaned up. Once completed, there are no users logged on so the “dummy” user can be freed up and sent back to Winlogon allowing it to perform its cleanup and logoff the system user. At this point, Winlogon sets its internal state to “logged out SAS” and displays the original splash screen. A shutdown or reboot will also force the logoff and closing of all desktops.

During this entire process there is a loosely coupled logging service (an application that runs on the system all the time from startup to shutdown) which is used for auditing purposes. It is an application that has an engine designed to process messages. The log messages come into a queue from the MUD GINA and are then passed to a process thread where they are “cracked” and the appropriate operations are performed on them. All log messages are sent to this logger to be outputted to a file or through a database layer to a specified database for viewing and auditing. This system is secure and provides for a detailed trail of all activities performed by individual users.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a workstation boot flowchart, the present invention;

FIG. 2 is an initial log on;

FIG. 3 is an unlock log in; and,

FIG. 4 is a logged on user.

### DETAILED DESCRIPTION OF THE PREFERRED EMBODIMENTS

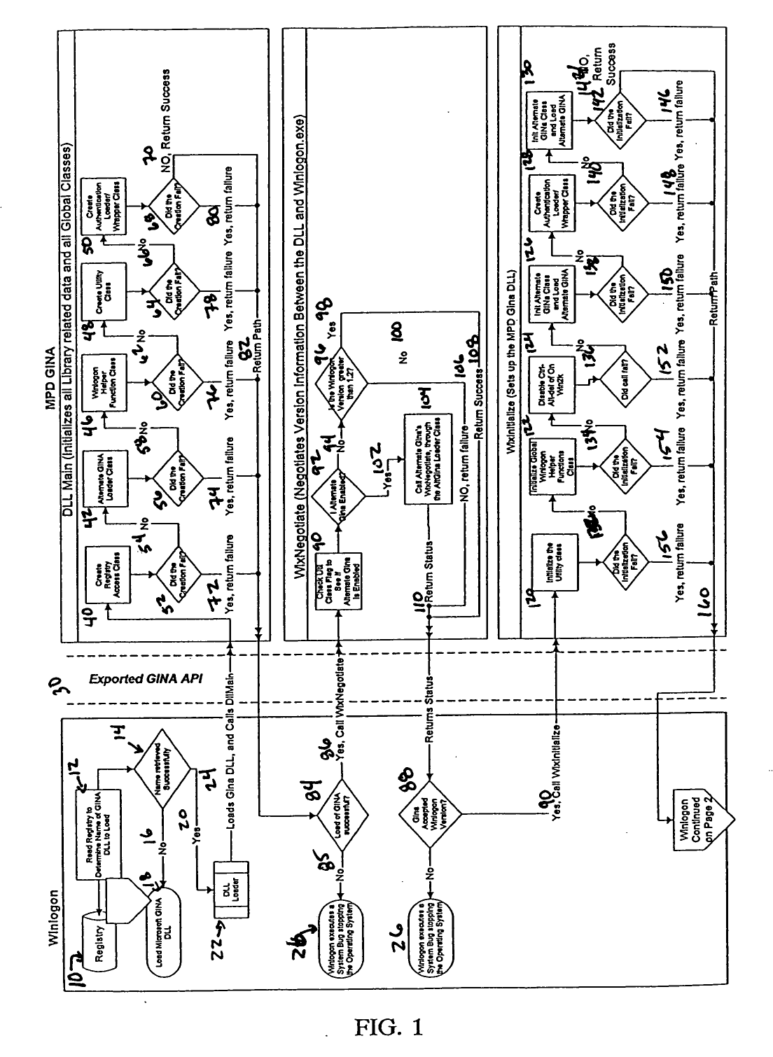

FIG. 1 is a workstation boot flowchart, the present invention shows the process that occurs when windows is booted and the registry 10 is read to determine the name of the GINA loaded 12, upon successful retrieval 20 of name 14, windows dll loader service 22 and continues to load Gina dll and calls dll main 24. If the name of the GINA in not successfully loaded 16 then the Microsoft GINA dll 18 is loaded. Windows loads the GINA dll 24 the GINA API is exported 30. Once exported the GINA API 30 asks to create registry access class 40. GINA API 30 then asks if the registry access class 40 failed 52 if the creation failed equals no 50 then alternate GINA loader class 42 is called. If GINA API 30 asks if registry class 40 failed 52 and if the creation failed equal yes 72 then the GINA DLL returns via return path 82 to ask if the load of GINA was successful 84 and when the return answer is no 85 then Winlogon executes a system bug stopping the operating system 26. If when GINA API 30 asks if create registry class 40 creation failed 52 and the answer is no 54 then GINA API 30 asks to create the alternate loader class 42. GINA API asks did the creation fail 56. If the create the alternate loader class 42 equals yes 74, then GINA API 30 returns via return path 82 to ask if the load of GINA was successful 84 and when the return answer is no 85 then winlogon executes a system bug stopping the operating system 26. The remainder of this figure follows what has been set fourth through this flowchart.

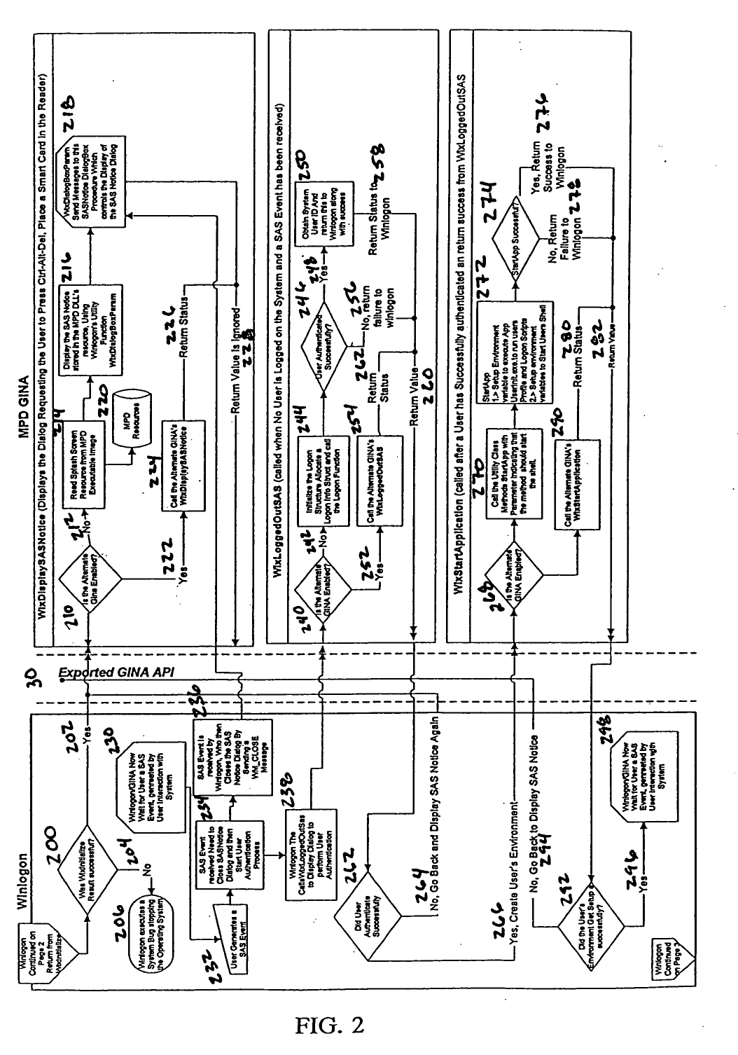

FIG. 2 is a flow chart of the initial log on process and the necessary steps to logon a user. The flow chart is self explanatory.

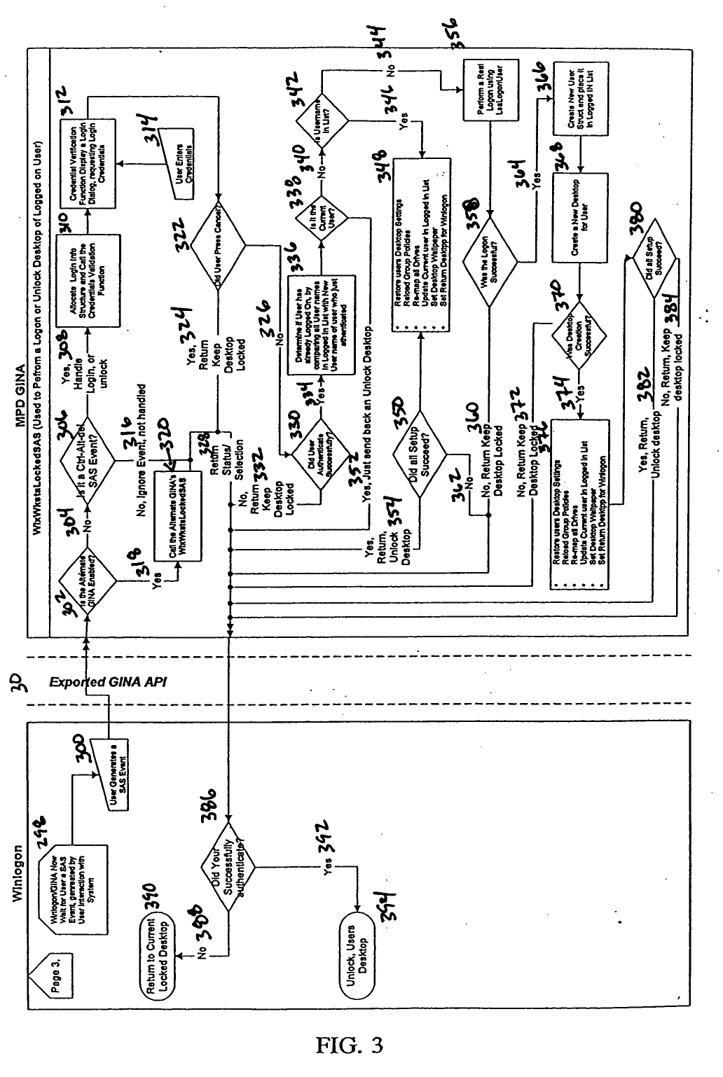

FIG. 3 is a flow chart of the unlock and login process and the step necessary to authenticate the logon. The flow chart is self explanatory.

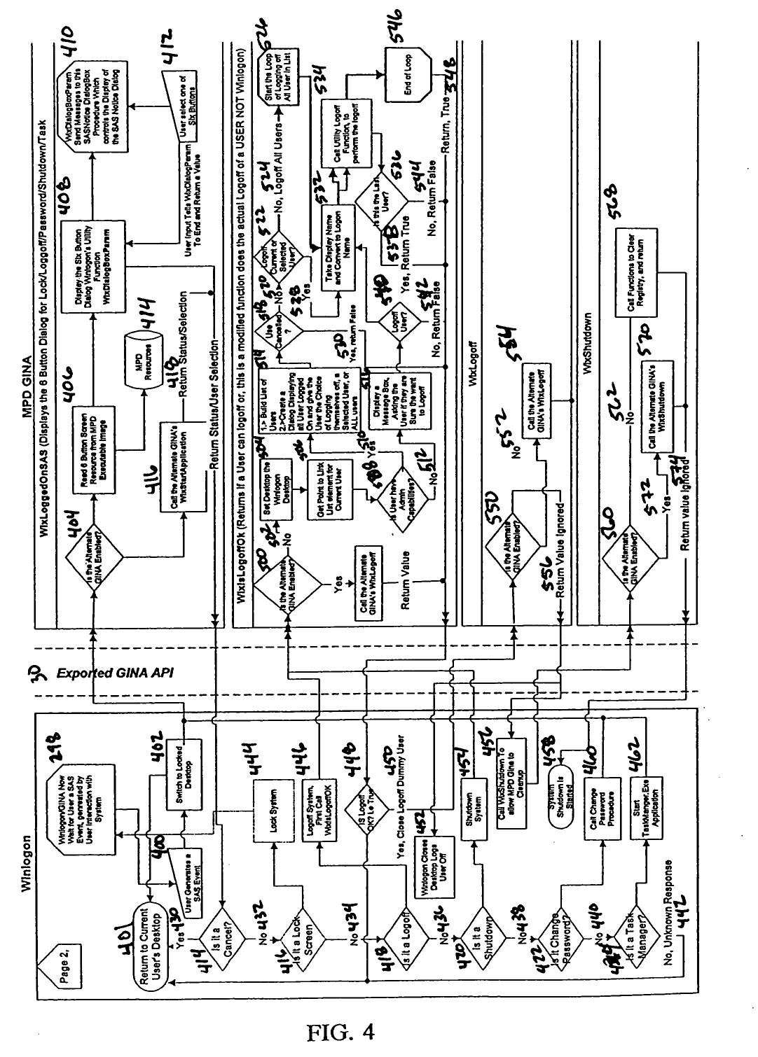

FIG. 4 is a flow chart of a logged on user and the options the user has to locking the screen, shutting down, changing the password, opening the task manager or cancelling an operation. The flow chart details the operations required and is self explanatory.

### Mode of Operation

The MUD GINA is a computer program in the form of a dynamic link library. A dynamic-link library (DLL) is a module that contains functions and data that can be used by another module (application or DLL). It is intended to be run on Microsoft Windows operating systems that are based on or derived from the Windows 32 bit NT architecture. The MUD GINA is basically a collection of functions that are made available to whoever loads it on the system. As a DLL, the MUD GINA can be used by another module and in this case the other module is an application called Winlogon.exe. Winlogon.exe handles interface functions that are independent of authentication policy. In the system, there are a required set of exported functions that the MUD GINA must make available to Winlogon.exe which in turn calls these functions based on its own internal “state.” The purpose of Winlogon.exe is to create the desktops for the window station, implement time-out operations, and during its initialization pass a set of support functions to the GINA which it may use.

When the computer is started up and after the initialization of the hardware and the operating systems takes place the Winlogon.exe application is started. After Winlogon.exe completes its internal initialization it looks into the system registry to obtain the name of the GINA DLL to load. The MUD GINA DLL name is placed in the register during its install so Winlogon.exe will find and load the MUD GINA.

After loading the MUD GINA Winlogon.exe and the MUD GINA must communicate initialization information, handle secure attention sequence (SAS) monitoring and notification, and permit logoff and shutdown activities.

The state of Winlogon.exe determines which GINA function is called to process any given SAS event. Communications occur in the order shown here:

| Event | Description |
|---|---|
| Workstation boot: | Winlogon calls the MUD GINA's |
| | WlxNegotiate function to notify the |
| | GINA about its version and what |
| | support functions are available. |
| | Winlogon calls the MUD GINA's |
| | WlxInitialize function to give the |
| | GINA the addresses of the support |
| | functions, a handle to Winlogon, |
| | and to obtain the MUD GINA's |
| | context information (This is an |
| | opaque internal memory buffer |
| | created by MUD GINA and is to be |
| | passed in all future calls to the |
| | GINA's exported functions). |
| | Current state: Winlogon is in the |
| | logged-out state. |
| No one is logged on: | (The MUD GINA monitors devices for |
| | SAS events, like Ctrl-Alt-Del). |
| | The MUD GINA calls Winlogon's |
| | WlxSasNotify function when an SAS |
| | event has been received. |
| | Winlogon calls the GINA's |
| | WlxLoggedOutSAS function, allowing |
| | the GINA to process a user's |
| | identification and authentication |
| | information. The MUD GINA does |
| | process the user's logon |
| | credentials but does not return |
| | them to Winlogon; it instead |
| | creates the desktop, runs the |
| | profile and policies and sends back |
| | the “system” user. This is done to |
| | prevent problem when the first user |
| | logs off the system which in turn |
| | would log everyone off. A default |
| | user is sent back to Winlogon that |
| | never logs off until the last user |
| | logs off or the system shuts down. |
| | Current state: When logon is |
| | successful, Winlogon is in the |
| | logged-on state. |
| The user is logged | (The MUD GINA monitors devices for |
| on: | SAS events). |
| | The MUD GINA calls Winlogon's |
| | WlxSasNotify function when an SAS |
| | event has been received. |
| | Winlogon calls the MUD GINA's |
| | WlxLoggedOnSAS function, allowing |
| | the MUD GINA to present options to |
| | the user who is currently logged |
| | on. |
| The user is logged on | (The GINA monitors devices for SAS |
| and wants to lock | events, like Ctrl-Alt-Del). |
| computer: | The MUD GINA calls Winlogon's |
| | WlxSasNotify function when an SAS |
| | event has been received. |
| | Winlogon calls the MUD GINA's |
| | WlxLoggedOnSAS function, the user |
| | who is currently logged on. |
| | The MUD GINA returns |
| | WLX_SAS_ACTION_LOCK_WKSTA. |
| | Current state: Winlogon is in the |
| | workstation-locked state. |
| The user is logged | (The GINA monitors devices for SAS |
| on; the workstation | events). |
| is locked; and the | The GINA calls the WlxSasNotify |
| user wants to unlock | function. |
| computer: This is | Winlogon calls the GINA's |
| where the MUD GINA is | WlxWkstaLockedSAS function. |
| SIGNIFICANTLY | The MUD GINA presents a normal |
| different from | Logon Screen. |
| Microsoft's GINA | If it is the same user who |
| | locked the workstation the |
| | user must perform a logon as |
| | they did at the logged out |
| | SAS. |
| | If it is a new user then he or |
| | she may logon to the system at |
| | this point. |
| | The credentials are check to see if |
| | it is a new user or an existing |
| | user. |
| | If it is a new user then a |
| | desktop is created and the |
| | profile and policies are run |
| | for the user and the desktop |
| | is set to point to the newly |
| | create one. |
| | If it is an existing user then |
| | the Winlogon is called to set |
| | the desktop “on” corresponding |
| | to the user who unlocked the |
| | screen. |
| | The GINA returns |
| | WLX_SAS_ACTION_UNLOCK_WKSTA. |
| The user is logged | Winlogon calls the GINA's WlxLogoff |
| on, and the program | function. |
| calls the | |
| ExitWindowsEx | |
| function: | |
| The user is logged on | (The MUD GINA monitors devices for |
| and wants to log off | SAS events) |
| using SAS: | The GINA calls the WlxsasNotify |
| | function. |
| | Winlogon calls the GINA's |
| | WlxLoggedOnSAS function. |
| | If there are no more users running |
| | on the system or the user selected |
| | logoff all users: |
| | The GINA will return |
| | WLX_SAS_ACTION_LOGOFF |
| | Winlogon will call the GINA's |
| | WlxLogoff function. |
| | If there is another user still |
| | logged on and the current user |
| | selects to log them off. |
| | Then only this users desktop |
| | must be closed and it is |
| | locked up in the list. |
| | WlxCloseDesktop is called to |
| | close the desktop. |
| | The MUD GINA logs the user out |
| | of the system. |
| | MUD GINA returns |
| | WLX_SAS_ACTION_LOCK_WKSTA. |

Various modifications can be made to the present invention without departing from the apparent scope thereof.

1. A process for operating a computer, comprising:
a. a workstation booting;
b. an initial logging on;
c. an unlock logging in; and,
d. logging on a user.
